(19) United States
(12) Patent Application Publication
(10) Pub. No.: US 2002/0090410 A1
(43) Pub. Date: Jul. 11, 2002

(54) Powder material removing apparatus and three dimensional modeling system

(76) Inventors: Shigeaki Tochimoto, Takatsuki-Shi (JP); Naoki Kubo, Nishinomiya-Shi (JP); Motohiro Nakanishi, Sakai-Shi (JP); Akira Wada, Osaka-Shi (JP)

Correspondence Address: SIDLEY AUSTIN BROWN & WOOD LLP, 717 NORTH HARWOOD, SUITE 3400, DALLAS, TX, 75201, US

(21) Appl. No.: 10/041,250

(22) Filed: Jan. 8, 2002

(30) Foreign Application Priority Data
Jan. 11, 2001 (JP) 2001-004132
Jan. 11, 2001 (JP) 2001-004133

(51) Int. Cl. B29C 41/02

(52) U.S. Cl. 425/215

(57) ABSTRACT

The present invention relates to a removing apparatus for removing unbonded powder material remaining around a three dimensional model which is a bonded structure of the powder material.

### RELATED APPLICATIONS

This application is based on applications Nos. 2001-4132 and 2001-4133 filed in Japan, the entire content of which is hereby incorporated by reference.

### BACKGROUND OF THE INVENTION

1. Field of the Invention

The present invention relates to a powder material removal technique for removing unbonded powder material from a three-dimensional model formed by selectively bonding powder particles.

2. Description of the Related Art

Three dimensional modeling apparatuses are known in the art which form a three dimensional model by repeating the steps of spreading a powder material in a thin layer over a model forming stage and then depositing a binder to selected regions of the layer to form a bonded structure of bonded powder.

Since the three dimensional model formed by such a three dimensional modeling apparatus is buried under unbonded powder material when the structure is completed, the three dimensional model has to be “excavated” by human hands from the structure covered with such unwanted powder material. Then, visual inspection is made to determine whether the unbonded powder material has been removed from the three dimensional model.

However, the drawback to excavating the three dimensional model by hand is that it is inefficient because it has to be done cautiously so as not to destroy the three dimensional model. Another drawback is that the working environment worsens because of dust particles flying around during the manual excavation work. Furthermore, the worker has to perform the excavation work while checking whether the powder material has been fully removed during the work.

### SUMMARY

It is an object of the present invention to provide a powder material removal technique capable of efficiently removing unwanted powder material from a three dimensional model.

It is another object of the present invention to provide a powder material removing apparatus that can properly determine whether removal of unwanted powder material from the three-dimensional object has been completed or not.

The present invention relates to a removing apparatus for removing unbonded powder material remaining around a three dimensional model which is a bonded structure of the powder material.

The invention itself, together with further objects and attendant advantages, will best be understood by reference to the following detailed description taken in conjunction with the accompanying drawings.

### BRIEF DESCRIPTION OF THE DRAWINGS

FIG. 1 is a diagram showing the construction of essential parts in a three dimensional modeling system 1 which incorporates a powder removing apparatus 70 according to a first embodiment of the present invention;

FIG. 2(a) is a diagram showing cross sections of a meshed tray 9;

FIG. 2(b) is a diagram showing cross sections of a model forming stage 62;

FIG. 3 is a flowchart illustrating the basic operation of the three dimensional modeling system 1;

FIG. 4 is a flowchart for explaining a powder removing operation;

FIG. 5 is a diagram for explaining the powder removing operation;

FIG. 6 is a diagram for explaining the powder removing operation;

FIG. 7 is a time chart for explaining the powder removing operation;

FIG. 8 is a diagram for explaining the powder removing operation;

FIG. 9 is a diagram showing the construction of essential parts in a three dimensional modeling system 1A which incorporates a powder removing apparatus 70A according to a second embodiment of the present invention;

FIG. 10 is a diagram for explaining the powder removing operation;

FIG. 11 is a diagram for explaining the powder removing operation;

FIG. 12 is a diagram showing the construction of essential parts in a three dimensional modeling system 1B which incorporates a powder removing apparatus 70B according to a third embodiment of the present invention;

FIG. 13 is a diagram for explaining the powder removing operation;

FIG. 14(a) is a diagram for explaining a model forming unit 6 according to a modified example of the present invention;

FIG. 14(b) is a diagram for explaining a model forming unit 6 according to a modified example of the present invention;

FIG. 15 is a diagram showing the construction of an essential portion of a blower unit WU according to a modified example of the present invention;

FIG. 16 is a diagram for explaining the powder removing operation;

FIG. 17 is a diagram for explaining a refresh unit 85 according to a modified example of the present invention;

FIG. 18 is a diagram showing the construction of an essential portion of the refresh unit 85;

FIG. 19 is a diagram showing the construction of an essential portion of a refresh unit 86;

FIG. 20 is a flow chart for explaining the process for determining the completion of powder removal; and

FIG. 21 is a diagram for explaining a powder removing apparatus 70C according to a modified example of the present invention.

In the following description, like parts are designated by like reference numbers throughout the several drawing.

### DESCRIPTION OF THE PREFERRED EMBODIMENT

<Embodiment 1>

<Construction of Essential Parts of Three Dimensional Modeling System 1>

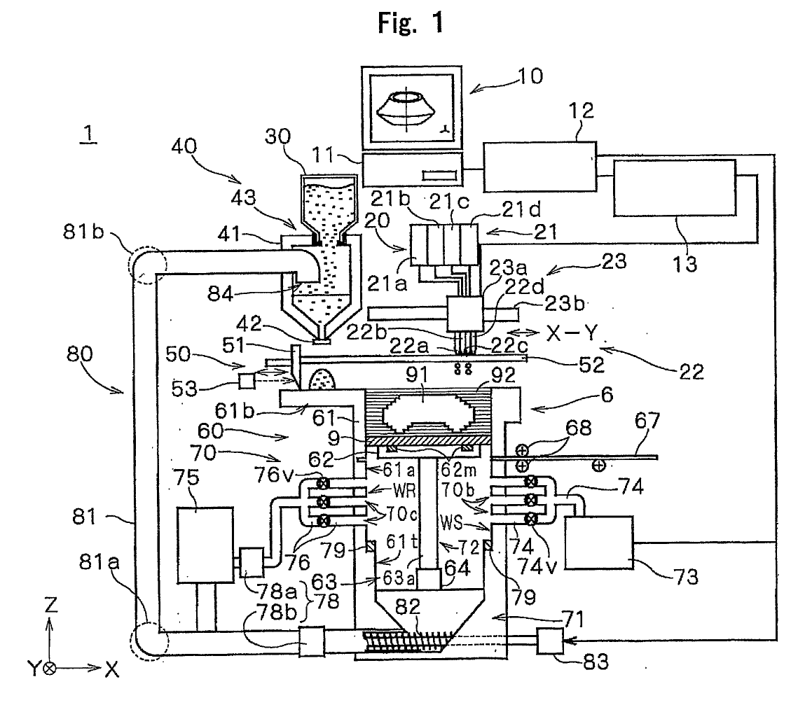

FIG. 1 is a diagram showing the construction of essential parts in a three dimensional modeling system 1 which incorporates a powder removing apparatus 70 according to a first embodiment of the present invention. The three dimensional modeling system 1 sequentially forms structures of bonded powder material one on top of another by repeating the step of selectively depositing a binder material to a powder material and thereby bonding the powder material, and produces a three dimensional model as a final bonded structure.

The three dimensional modeling system 1 comprises a control unit 10, and a binder dispensing unit 20, a model forming unit 6, a powder dispensing unit 40, a powder spreading unit 50, and a powder recovering unit 80, which respectively are electrically connected to the control unit 10. The powder removing apparatus 70, constructed integrally with a model forming apparatus 60 into a single unit, constitutes the model forming unit 6.

<Construction of the Control Unit 10>

The control unit 10 comprises a computer 11, a drive control unit 12 electrically connected to the computer 11, and a nozzle head driving unit 13 electrically connected to the drive control unit 12.

The computer 11 is an ordinary desk top computer or the like which contains a CPU, memory, timer, etc. The computer 11 converts a target three dimensional structure into shape data, and supplies cross section data, obtained by slicing the structure into many thin layers of cross sections, to the drive control unit 12.

Based on the cross section data supplied from the computer, the drive control unit 12 controls the operation of various units. When the cross section data is acquired from the computer 11, the drive control unit 12, based on the cross section data, issues drive commands to the various units to centrally control the operation of the model forming apparatus 60 in the model forming unit 6 for sequentially forming bonded structures of powder material on a layer by layer basis. The drive control unit 12 also centrally controls the operation of the powder removing apparatus 70 in the model forming unit 6 for removing powder particles left unbonded after completing the model forming.

<Construction of the Binder Dispensing Unit 20>

The binder dispensing unit 20 comprises a tank unit 21 for storing liquid binders each used as a binder material for binding the powder material, a nozzle head 22 through which the binders in the tank 21 are dispensed, and an XY-direction driving unit 23 for moving the nozzle head 22 in a horizontal XY plane.

The tank unit 21 comprises a plurality of tanks (four tanks in the illustrated example) 21a to 21d for holding therein binders of different colors. More specifically, binders of three primary colors of Y (yellow), M (magenta), and C (cyan) and a binder of W (white) color are held in the tanks 21a to 21d, respectively. For the colored binders, it is desirable to use materials that do not discolor when mixed with the powder material, and that do not discolor or fade with age.

The nozzle head 22 is fixed to the underside of the XY-direction driving unit 23, and is movable within the XY plane in integral fashion with the XY-direction driving unit 23. The nozzle head 22 comprises dispensing nozzles 22a to 22d the number of which is equal to the number of tanks in the tank unit 21, and the dispensing nozzles 22a to 22d are connected to the corresponding tanks 21a to 21d through four tubes. Each of the dispensing nozzles 22a to 22d is a nozzle that dispenses (ejects) the binder as tiny droplets using, for example, an inkjet printing technique. The binder dispensing operation of each of the dispensing nozzles 22a to 22d is individually controlled by the nozzle head driving unit 13, and the binders ejected through the dispensing nozzles 22a to 22d adhere to a powder layer 92 in the model forming apparatus 60 which is disposed opposite the nozzle head 22.

The XY-direction driving unit 23 comprises a drive main unit 23a and a guide rail 23b. The drive main unit 23a is movable reciprocally in the X direction along the guide rail 23b as well as in the Y direction. That is, the nozzle head 22 can be moved by the XY-direction driving unit 23 within the plane defined by the X- and Y-axes. More specifically, based on a drive command given from the nozzle head driving unit 13, the XY-direction driving unit 23 can move the nozzle head 22 to the desired position within the driving range in that plane. The nozzle driving unit 13 performs control so as to select an appropriate one of the plurality of dispensing nozzles 22a to 22d to dispense the binder according to the position of the nozzle head 22 in the XY plane so that the binder is deposited to selected regions of the powder layer 92 in the model forming apparatus 60.

<Construction of the Model Forming Unit 6>

The model forming unit 6 comprises a model forming bath 61 having a recessed portion, a model forming stage 62 provided so as to form the bottom of the recessed portion of the model forming bath 61, a Z-direction moving unit 63 for moving the model forming stage 62 in the Z direction, and a driving unit 64 for driving the Z-direction moving unit 63.

The model forming bath 61 serves the function of providing a working area where a three dimensional model 91 is formed using a powder material. The model forming bath 61 has a temporary powder holding portion 61b formed at an upper edge thereof for temporarily holding thereon the powder material dispensed from the powder dispensing unit 40.

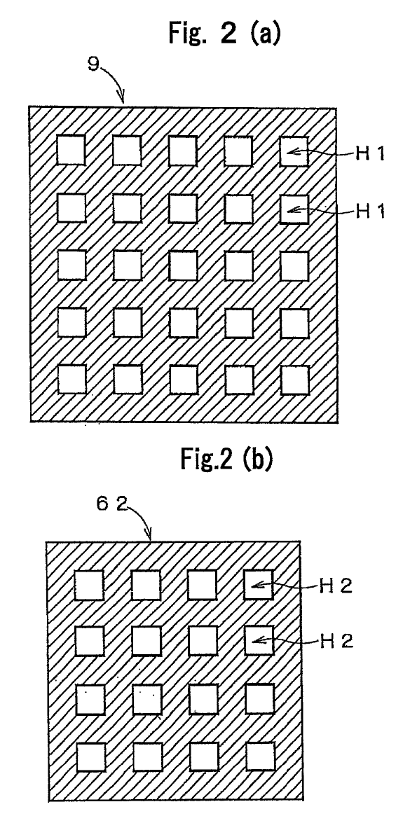

The model forming stage 62 has a rectangular shape having a meshed cross section taken along the XY plane, as shown in FIG. 2(b), and contacts on its sides the vertical inner wall 61a of the recessed portion of the model forming bath 61. A meshed tray 9 having the cross section shown in FIG. 2(a) is placed on the model forming stage 62.

The model forming stage 62 has two electromagnets 62m on its upper surface. The electromagnets 62m serve to fixedly hold the meshed tray 9 formed from a metal.

The rectangular parallelepiped three dimensional space (that is, the space in the recessed portion) bounded by the model forming stage 62 and the vertical inner wall 61a of the model forming bath 61 provides the model forming area for forming the three dimensional model 91. Thin layers of powder material are sequentially formed layer by layer on the meshed tray 9 placed on the model forming stage 62; as each layer is formed, the dispensing nozzles 22a to 22d dispense binders to bind the powder material in selected regions, and the model is formed by repeating this process.

The Z-direction moving unit 63 includes a supporting rod 63a connected to the model forming stage 62. The model forming stage 62 connected to the supporting rod 63a can be moved in the Z direction by moving the supporting rod 63a in vertical direction by means of the driving unit 64.

<Construction of the Powder Removing Apparatus 70>

The powder removing apparatus 70 includes a collection chamber 71 in which removed powder is collected, a processing chamber 72 in which unbonded powder is removed, a blower unit WS, and a suction unit WR.

The blower unit WS comprises a blower driving unit 73 for generating an air stream, a pipe 74 extending from the air outlet of the blower driving unit 73 and branching into three pipes which terminate at three blower apertures 70b in the vertical inner wall 61a at positions spaced apart from each other (in this embodiment, the apertures are spaced apart vertically), and three blower valves 74v inserted in the respective pipes 74.

The blower driving unit 73 is equipped with an air blower which blows air into the processing chamber 72 through the pipes 74.

Each blower valve 74v is an electromagnetic valve which automatically opens or closes the corresponding blower aperture 70b in response to a command signal given from the control unit 10. By selectively opening or closing the three blower valves 74v, air can be blown into the processing chamber 72 through the selected blower aperture(s) 70b.

The suction unit WR comprises a suction driving unit 75 for sucking air from the processing chamber 72, a pipe 76 extending from the suction inlet of the suction driving unit 75 and branching into three pipes which terminate at three suction apertures 70c in the vertical inner wall 61a at positions spaced apart from each other (in this embodiment, the apertures are spaced apart vertically), and a flow rate sensor 78a and three suction valves 76v inserted in the pipes 76. A flow rate sensor 78b similar to the flow rate sensor 78a is provided at an intermediate point along a powder conveying pipe 81 described later. The suction unit WR also functions as a recycling unit for recycling the sucked powder material to the powder dispensing unit 40.

The suction driving unit 75 is apart that sucks unbonded powder by generating air streams in the processing chamber 72 through the pipes 76.

Each suction valve 76v is an electromagnetic valve which automatically opens or closes the corresponding suction aperture 70c in response to a command signal given from the control unit 10. By selectively opening or closing the three suction valves 76v, unbonded powder can be sucked from the processing chamber 72 through the selected suction aperture(s) 70c.

The powder removing apparatus 70 further includes a weight sensor 79 mounted on a protruding portion 61t of the vertical inner wall 61a, a shutter 67 provided at a point halfway along the height of the vertical inner wall 61a, and three driving rollers 68 for driving the shutter 67 in the X direction.

The weight sensor 79 is a sensor that measures the weight of the load placed on the meshed tray 9, including the three dimensional model 91.

When the three dimensional model 91 buried under unbonded powder is moved into the processing chamber 72 by lowering the model forming stage 62, the blower driving unit 73 is activated, and the blower valves 74v are opened to blow air into the processing chamber 72 through the blower apertures 70b. At the same time, the suction driving unit 75 is activated, and the suction valves 76v are opened to suck unbonded powder through the suction apertures 70c.

In this powder removing operation, the powder material falling off the three dimensional model 91 is passed through the holes H1 and H2 (FIG. 2) opened in the meshed tray 9 and the model forming stage 62, respectively, and is collected in the collection chamber 71.

<Construction of Essential Parts of the Powder Recovering Unit 80>

A powder conveying screw 82 is provided at the bottom of the collection chamber 71. The powder conveying screw 82 forms part of the powder recovering unit 80 that conveys the collected powder material to the powder dispensing unit 40.

The powder recovering unit 80 includes a powder conveying pipe 81 and a driving unit 83, in addition to the powder conveying screw 82. The powder conveying pipe 81 extends from the bottom of the collection chamber 71 to the interior of a tank 41 in the powder dispensing unit 40. The powder conveying screw 82 is formed from a flexible member, and is installed inside the powder conveying pipe 81 in such a manner as to extend from the bottom of the collection chamber 71 to a pipe end 84 located inside the tank 41. Though the powder conveying pipe 81 has two bends 81a and 81b, the powder conveying screw 82 formed from a flexible member can be installed through the powder conveying pipe 81 by being bent along the curvatures of the bends 81a and 81b. Here, it is preferable that the bends 81a and 81b each have a large radius of curvature so that the rotational driving force of the screw can be transmitted effectively as a screw driving force from one side to the other side of each bend.

One end of the powder conveying screw 82 is connected to a rotating shaft of the driving unit 83 which comprises a motor or the like; with the driving unit 83 producing a rotational driving force in a prescribed direction, the powder conveying screw 82 is driven for rotation about its center axis in the prescribed direction. The rotational driving force is effectively transmitted to the powder conveying screw 82 despite the presence of the bends 81a and 81b, and the entire powder conveying screw 82 installed inside the powder conveying pipe 81 is driven for rotation about its center axis in interlocking fashion with the driving unit 83.

In this way, the powder material collected in the collection chamber 71 is conveyed through the powder conveying pipe 81 by the powder conveying screw 82, and recycled to the tank 41 in the powder dispensing unit 40 so that the powder material can be reused.

<Construction of Essential Parts of the Powder Dispensing Unit 40>

The powder dispensing unit 40 comprises, in addition to the tank 41 for holding powder material, a shut-off plate 42 provided at the powder dispensing port (outlet) of the tank 41 for opening or closing the powder dispensing port of the tank 41 in response to a command given from the drive control unit 12.

The tank 41 holds therein, for example, a white powder material. The powder material is the material used for forming the three dimensional model 91, and is made, for example, of starch powder, resin powder, or the like.

A container mounting portion 43 for mounting a powder material container 30 which contains virgin powder material is provided in the top of the tank 41.

The shut-off plate 42 is mounted so as to be slidable in a horizontal direction (X direction) and, in response to a drive command given from the drive control unit 12, opens or closes the dispensing port of the tank 41 to dispense or stop the dispensing of powder material to the temporary powder holding portion 61b of the model forming unit 6.

The powder spreading unit 50 comprises a blade 51, a guide rail 52 for regulating the movement of the blade 51, and a driving unit 53 for moving the blade 51.

The blade 51 has a shape extending longitudinally in the Y direction and having a sharpened bottom edge. The length of the blade 51 in the Y direction is made sufficient to cover the width in the Y direction of the recessed portion of the model forming bath 61. A vibration mechanism for giving fine vibrations to the blade may be included so that the blade 51 can spread (disperse) the powder material smoothly.

The driving unit 53 is capable of moving the blade 51 up and down along the vertical direction (Z direction) as well as reciprocally along the horizontal direction (X direction) With the driving unit 53 operating in response to a command given from the drive control unit 12, the blade 51 can be moved in the X and Z directions.

<Operation of the Three Dimensional Modeling System 1>

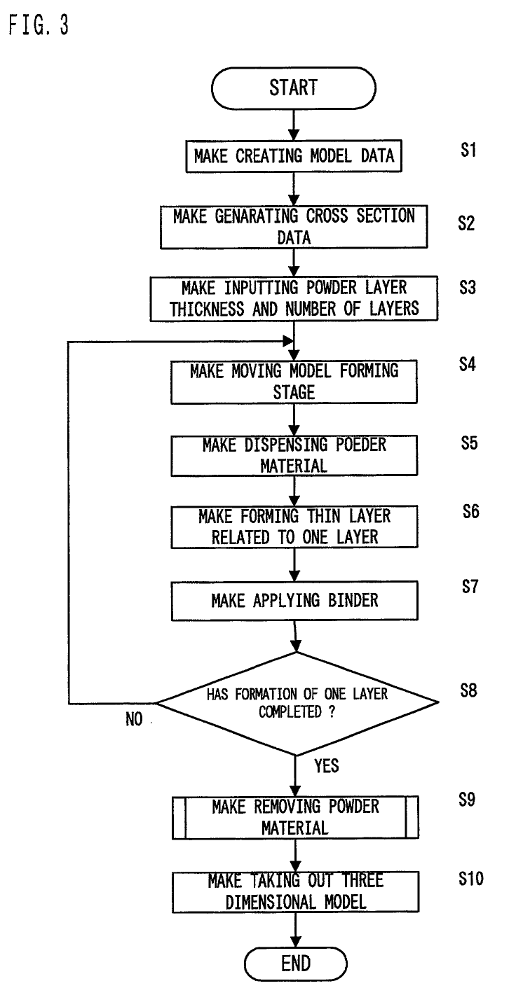

FIG. 3 is a flowchart illustrating the basic operation of the three dimensional modeling system 1. The illustrated operation is automatically executed by the control unit 10.

In step S1, the computer 11 creates model data representing a three dimensional model with a color pattern, etc. formed on its surface. For the three dimensional shape data based on which to form the model, colored three dimensional model data created by conventional three dimensional CAD modeling software can be used. It is also possible to use texture and shape data measured by a three dimensional shape input device.

In some kinds of model data, color information is provided only for the surfaces of the three dimensional model, and in others, color information is also provided for the interior of the model. In the latter case, only the color information for the surfaces of the model may be used when forming the model, or the color information for the interior of the model may also be used. For example, when creating a three dimensional model of a human body or the like, one may want to use different colors for different internal organs; in such cases, the color information for the interior of the model is used.

In step S2, the computer 11 generates, from the model data, cross section data for each of the cross sections into which the model to be formed has been horizontally sliced. More specifically, cross section data containing shape data and color data are generated by slicing the model data into cross sections at a pitch equivalent to the thickness of each of the powder layers to be stacked. The slice pitch can be varied within a prescribed range (the range of thickness within which powder particles can be bonded together to form a layer).

In step S3, information concerning the powder layer thickness (the slice pitch used when generating the cross section data) and the number of layers to be stacked (the number of cross section data sets), used when forming the model, is entered from the computer 11 to the drive control unit 12.

Step S4 and subsequent steps are carried out with the control unit 10 controlling the various units.

In step S4, to form an N-th (N=1, 2, . . . ) layer of bonded powder material on the model forming stage 62, the Z-direction moving unit 63, based on the layer thickness entered from the computer 11, moves the model forming stage 62 downward by a distance equivalent to the layer thickness and holds the model forming stage 62 in that position. This provides a space for a new powder layer to be formed on top of the already bonded powder layer structure formed on the model forming stage 62. When N=1, since this means the first layer to be formed, the space is provided on the upper surface of the meshed tray 9 itself.

Here, the meshed tray 9 is placed on the model forming stage 62 in such a manner as to close the holes H1 (FIG. 2), and the meshed tray 9 is fixed to the model forming stage 62 by energizing the electromagnets 62m. The powder can thus be held on the model forming stage 62 and prevented from falling through the holes.

In step S5, powder as the material for forming the three dimensional model is dispensed. The shut-off plate on the powder dispensing unit 40 is slid open from the closed position to deposit a prescribed amount of powder material from the tank 41 onto the temporary powder holding portion 61b of the model forming unit 6. The prescribed amount is set slightly larger than the volume of the above-described space (the necessary amount of powder used for forming the layer). When forming the first layer (N=1), it is preferable to set the amount slightly larger than that for subsequent layers (N>1), by considering the amount of powder material that enters the interstices of the meshed tray 9. After dispensing the prescribed amount of powder material, the shut-off plate 42 is moved back to the closed position to stop the dispensing of the powder material.

In step S6, the powder material deposited in step S5 is spread over the model forming stage 62 to form a thin layer of powder material. That is, by moving the blade 51 n the X direction, the powder deposited on the temporary powder holding portion 61b is moved into the space provided on the model forming stage 62 for thin layer formation, and a thin powder layer 92 of uniform thickness is thus formed. At this time, the bottom edge of the blade 51 is moved across the uppermost surface of the model forming unit 6. This ensures the formation of a thin layer of powder material of specified thickness.

After the powder layer 92 has been formed, the blade 51 is moved up away from the uppermost surface by the driving unit 53 and is returned to its initial position by passing above the powder layer 92.

In step S7, the nozzle head 22 is moved within the XY plane by driving the XY-direction driving unit 23 in accordance with the shape data and color data created in step S2. In this case, the required time can be reduced by scanning only the regions for which the shape data has been generated. While the nozzle head 22 is being moved, colored binders are selectively ejected from the dispensing nozzles 22a to 22d. The bonded powder structure is thus formed. Powder particles where the binders have not been applied (unbonded powder particles) remain unbonded to each other.

Here, when applying the binders to the portions corresponding to the surface portions of the three dimensional model 91, the Y, M, C, and W binders are selectively dispensed based on the color information derived from the model to be formed. Colors can thus be applied to the surfaces of the model during the formation of the three dimensional model 91, achieving colored model forming. On the other hand, for those portions of the three dimensional model which do not need coloring (non-colored regions), the W binder, which does not interfere with the colored state of the colored regions, is applied during the formation of the model.

It is preferable to apply the same amount of binder per unit area to every portion of the model to be formed in order to secure the strength of the bonded structure by uniformly distributing the binders in the powder layer 92. For example, if the product of the moving speed of the dispensing nozzles 22a to 22d driven by the XY-direction driving unit 23 and the amount of binder dispensed from the dispensing nozzles 22a to 22d per unit time (for example, the number of binder droplets) is maintained constant, the same amount of binder per unit area can be applied uniformly.

After applying the binders, the binder dispensing operation is stopped, and the XY-direction driving unit 23 is driven to move the nozzle head 22 back to its initial position.

The binder dispensing step may be followed by a binder drying step. For example, the step of shining an infrared lamp or the like from above the powder layer 92 maybe included. With the provision of such step, the binders adhering to the powder layer 92 can be quickly dried. However, if the binders are of the type that quickly dries by itself, the drying step need not necessarily be provided.

When the formation of one layer is completed, the process proceeds to step S8 where the drive control unit 12 determines, based on the number of layers entered in step S3, whether the formation of all the layers has been completed or not. That is, it is determined here whether the formation of the three dimensional model 91 has been completed or not. If it is determined that the model forming is completed, the process proceeds to step S9; otherwise, the process from step S4 onward is repeated.

When the process returns to step S4, a new structure of bonded powder material, i.e., the (N+1) the layer, is formed on top of the N-th layer. By repeating such operation, colored bonded structures are sequentially formed on a layer by layer basis on the model forming stage 62, finally forming the three dimensional model 91 of the desired structure on the model forming stage 62. It is then determined in step S8 that the formation of the model has been completed.

In the above model forming operation, if the three dimensional model 91 to be formed is of a box shape having a recessed portion, for example, it is preferable to control the formation of the three dimensional model 91 by considering the next powder removal step S9, in such a manner that the opening of the recessed portion faces straight down so that unbonded powder particles are allowed to fall by gravity. If there are two or more recessed portions facing in different directions, it is preferable to form the three dimensional model 91 by orienting it in such a direction as to allow as much unbonded powder as possible to fall by gravity.

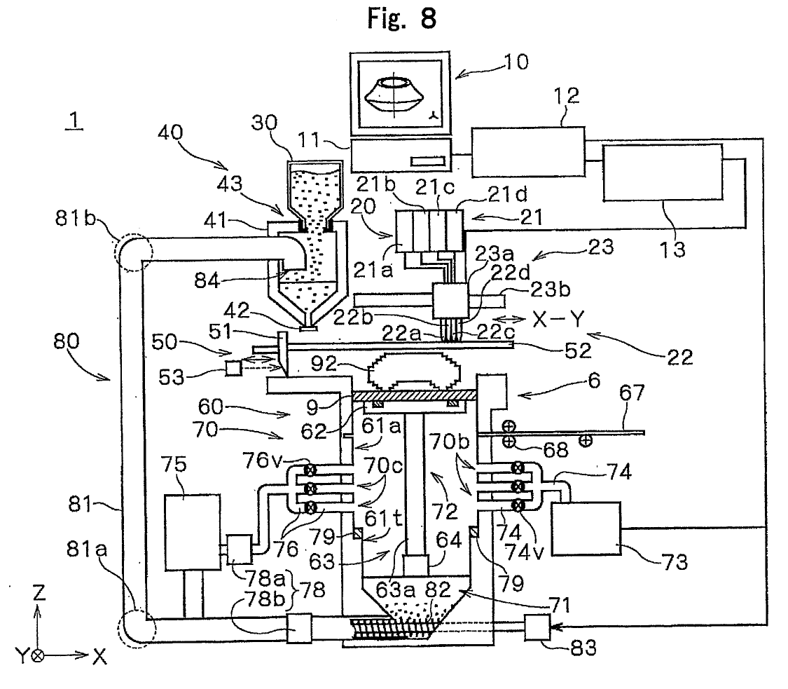

In step S9, powder removal to be described in detail later is performed. In step S10, the three dimensional model 91 from which the unbonded powder has been removed in step S9 is recovered. Here, the model forming stage 62 moves up to allow the three dimensional model 91 to be recovered, as shown in FIG. 8.

The sequence of operations in the three dimensional modeling system 1 is thus completed. According to the three dimensional modeling system 1 described above, since the apparatus is constructed so as to be able to automatically remove the unbonded powder adhering to the three dimensional model 91, the three dimensional model 91 can be recovered without causing powder particles to fly around in the ambient environment.

Further, in the three dimensional modeling system 1, the unbonded powder removed by the powder removing apparatus 70 is collected in the collection chamber 71, and the collected unbonded powder is recycled to the powder dispensing unit 40 by the powder recovering unit 80. That is, the unbonded powder can be recycled for reuse without the intervention of human hands.

<Operation for Powder Removal>

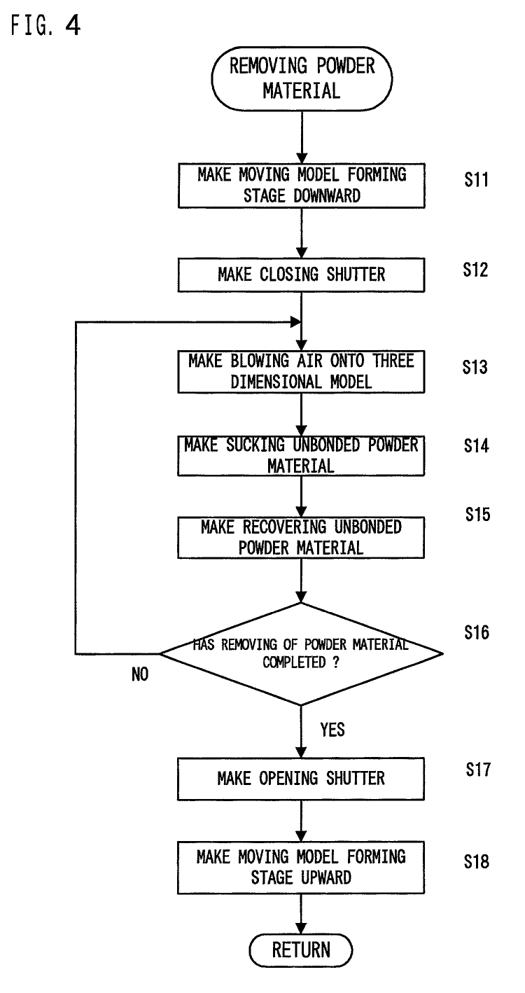

FIG. 4 is a flow chart for explaining the powder removing operation which corresponds to step S9 in the above-described process. In step S11 the model forming stage 62 is moved downward by the Z-direction moving unit 63, thus lowering the three dimensional model 91 into the powder removing apparatus 70. Here, the model forming stage 62 is lowered in the model forming bath 61, together with the meshed tray 9, the three dimensional model 91, and the unbonded powder covering the three dimensional model 91 placed on the model forming stage 62.

While the above operation is being performed, the nozzle head 22 is lifted away from the model forming stage 62, and is protected by a protective means (not shown) for protection from external dust particles and drying.

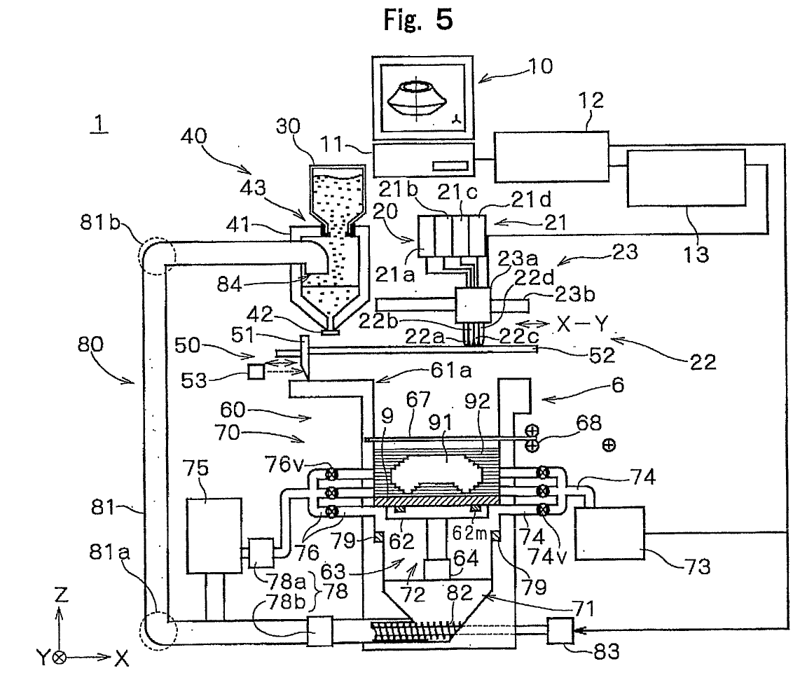

In step S12, when the model forming stage 62 is lowered to a position where the uppermost layer in the powder layer structure 92 is located lower than the shutter, as shown in FIG. 5, the shutter 67 retracted in its standby position is moved to close the top of the model forming bath 61.

The shutter 67 thus closed serves to prevent the unbonded powder particles from flying upward and floating in the ambient environment and also from adhering to the nozzle head 22 and other parts. It is desirable that the processing chamber 72 be hermetically sealed when the shutter 67 is closed.

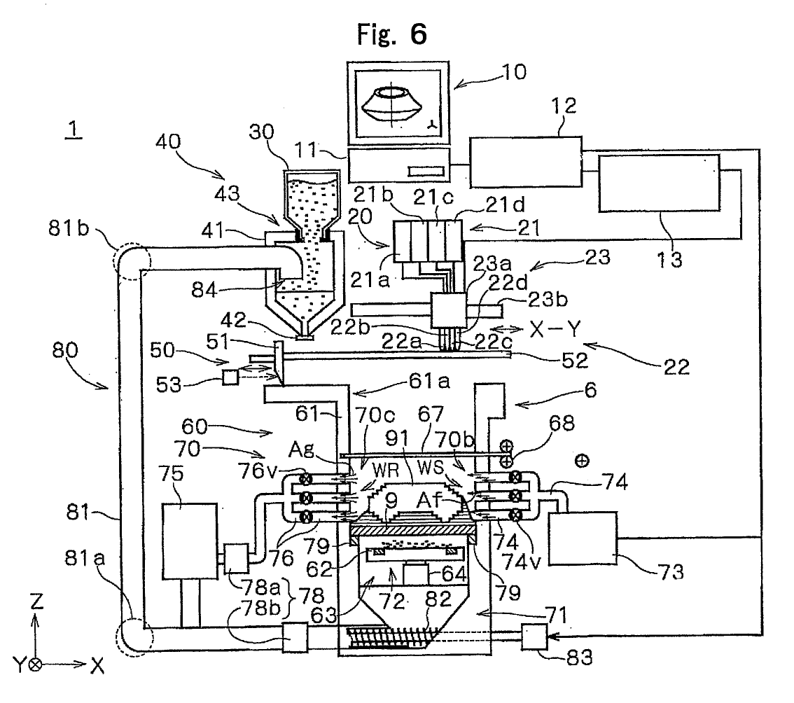

Then, when the model forming stage 62 is lowered to a position where the meshed tray 9 contacts the weight sensor 79 in the model forming bath 61, the electromagnets 62m acting to fix the meshed tray 9 to the model forming stage 62 is de-energized, allowing the meshed tray 9 to separate from the model forming stage 62. When the model forming stage 62 is further lowered, the meshed try 9 is caught by the weight sensor 79 in the model forming bath 61 and held there on by being separated from the model forming stage 62. With the meshed tray 9 separated from the model forming stage 62, part of the unbonded powder is allowed to fall downward through the holes H1 and H2 (FIG. 2) opened in the meshed tray 9 and the model forming stage 62, respectively (FIG. 6).

In step S13, the blower driving unit 73 is driven to generate a plurality of air streams Af through the blower apertures 70b as shown in FIG. 6, thus blowing air onto the three dimensional model 91. Here, the air blow control described below is performed by selectively opening or closing the blower valves 74v.

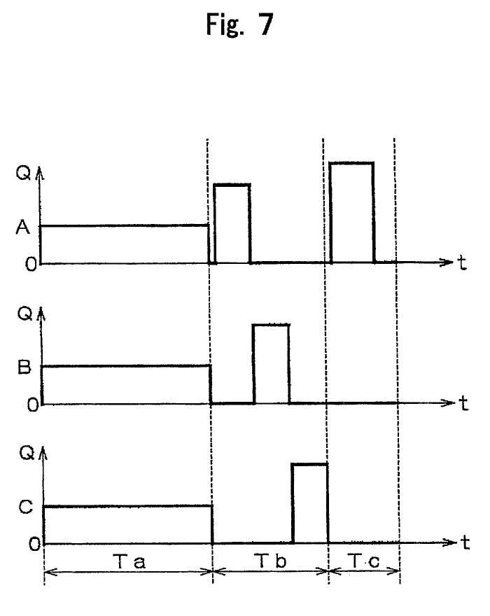

FIG. 7 is a diagram for explaining the air blow control in the processing chamber 72. In FIG. 7, time t is plotted along the horizontal axis, and air flow rate Q along the vertical axis.

During the time period Ta starting from air blow start time t=0, a constant amount of air is blown from the upper, middle, and lower apertures A, B, and C simultaneously. In this way, unbonded powder can be removed uniformly from the three dimensional model 91, achieving rough removal of the powder.

During the next time period Tb, air is blown by changing the blower apertures in sequence from the upper aperture A to the lower aperture C. Since unbonded powder can be removed working from the top toward the bottom of the three dimensional model 91, the powder can be removed utilizing gravity.

Finally, during the time period Tc, air is blown through the upper aperture A by increasing the amount of air. In this way, air can be blown intensively to the sloping portions in the upper part of the model where unbonded powder is difficult to remove by the air blow operation during the preceding time periods Ta and Tb. That is, considering the shape of the three dimensional model 91, air blow can be concentrated on the regions where powder is difficult to remove.

Effective powder removal can thus be achieved with the control unit 10 controlling the amount of air, etc. by considering such factors as the shape of the three dimensional model 91 and the amount of unbonded powder adhering to it.

In step S14, the suction driving unit 75 is driven to generate a plurality of air streams Ag through the suction apertures 70c, and the unbonded powder remaining on the three dimensional model 91 is drawn through the suction apertures 70c. Here, the three suction valves 76v are opened to draw the unbonded powder from the processing chamber 72, as shown in the diagram.

As in the air blow control described above, it is preferable to control the suction operation by considering the shape of the three dimensional model 91, etc.

In step S15, the unbonded powder that fell through the meshed tray 6 and the model forming stage 62 is recovered by the powder recovering unit 80. The unbonded powder that fell is collected in the collection chamber 71, and is recycled to the powder dispensing unit 40 by being conveyed on the rotating powder conveying screw 82.

In step S16, it is determined whether removal of the powder from the three dimensional model 91 has been completed or not.

More specifically, the time elapsing from the powder removal start time is counted by the internal timer of the computer 11, and this elapsed time is compared with a time value calculated by summing the time expected to be required to complete the powder removal with a time value corresponding to a prescribed margin.

The following five factors, for example, can be raised as the factors that affect the required time To.

1) The volume size of the powder material used to form the three dimensional model 91 (number, n, of layers stacked in the model forming bath 61×thickness, t, of each layer)

2) The amount of unbonded powder (number, n, of layers stacked in the model forming bath 61×thickness, t, of each layer-volume of the three dimensional model 91).

3) Complexity of surface geometry of the three dimensional model 91 (ratio of the surface area of the three dimensional model to the volume thereof).

4) The number of recesses in the surfaces of the three dimensional model 91.

5) The size of regions hidden by the three dimensional model 91 and therefore outside the reach of blown air.

Considering the above five factors, the required time To can be calculated as shown by the equation (1) below, where Tm represents the size of the margin. This calculation is performed in the control unit 10.

To=k1·D1+k2·D2+k3·D3+k4·D4+k5·D5+Tm (1)

Here, D1 to D5 are specific values representing the above factors 1) to 5), and k1 to k5 are weighting coefficients for the respective factors. These numeric values are obtained in advance by experiment.

Then, based on the three dimensional shape data, the required time To is read from a data table where the calculation result of the above equation (1) is prestored, and this required time To is set as the reference time for operating the powder removing apparatus 70. Here, the required time To may be obtained each time by calculation, rather than reading it from the data table.

The factors that can affect the required time To, other than the above five factors, include, for example, the fluidity of the powder material due to temperature, humidity, etc. It is preferable to calculate the required time To by also accounting for these factors as parameters.

If it is determined as the result of the above operation in step S16 that removal of the powder has been completed, the process proceeds to step S17; otherwise, the process returns to step S13.

In step S17, the operation of the powder removing apparatus 70 is stopped, and the shutter 67 set in the closed position is opened and thus retracted into its standby position as shown in FIG. 8.

In step S18, the driving unit 64 for the Z-direction moving unit 63 is driven to move the model forming stage 62 upward, thus drawing the three dimensional model 91 out of the powder removing apparatus 70. When the model forming stage 62 moves up to the position shown in FIG. 8, the three dimensional model 91 is ready to be recovered.

With the above operation of the powder removing apparatus 70, since air is blown to the three dimensional model through the plurality of blower apertures and sucked through the plurality of suction apertures to remove unbonded powder, the unwanted powder material can be efficiently removed and the three dimensional model easily recovered from the unbonded powder.

Further, with the above operation of the three dimensional modeling system 1, since removal of the unbonded powder can be performed automatically as part of the series of operations in the three dimensional modeling system 1, the user need not remove the unbonded powder by hand after forming the three dimensional model 91, and can recover the three dimensional model 91 without soiling his hands or clothes.

In the removal completion determination performed in step S16 described above, it is preferable to use, in addition to the method of determining the removal completion based on the required time, the method described below that makes the determination based on a measured value indicative of how far the removal of the unbonded powder material has progressed.

<Determination Based On Change of Weight Relating to Three Dimensional Model 91>

A method will be described below in which the weight of the load carried on the meshed tray 9, including the three dimensional model 91, is measured by the weight sensor 79 and the measured weight value is compared with a predetermined threshold value to determine whether the removal of the unbonded powder remaining on the three dimensional model 91 has been completed in the powder removing apparatus 70.

In this determination method, first the expected weight of the three dimensional model 91 is calculated in the control unit 10 in order to determine the above threshold value.

The weight Ma of the three dimensional model can be calculated from the three dimensional shape data based on which to form the three dimensional model 91, the volume and specific gravity of the powder material, and the volume and specific gravity of the binder material. More specifically, when the volume of the three dimensional model derived from the three dimensional data is denoted by Va, the percentage of powder loading by φp, the specific gravity of the powder by ρp, the volume of the binder material by Vb, and the specific gravity of the binder material by ρb, then the weight of the model is given by the following equation (2).

Ma=ρp×Va×φp+ρb×Vb (2)

When the value of the combined weight, measured by the weight sensor 79, of the three dimensional model 91 and the unbonded powder material remaining adhering to it satisfies the following conditions relative to the threshold value determined based on the weight of the three dimensional model 91 calculated by the above equation, the control unit 10 issues a command to stop the powder removing operation.

[1] (Weight measured by weight sensor−Weight of meshed tray) <(Weight Ma of model)×(1+α1)

Here, α1 is added considering the fact that it is difficult to accurately calculate the weight of the three dimensional model 91 by the above equation (2) since the percentage of powder loading in the three dimensional model 91 contains a certain degree of error.

[2] (Rate of change of weight measured by weight sensor) <β1

The rate of change of measured value means the amount of change per unit time of the value of the weight measured by the weight sensor 79.

Here, the powder removing operation may be completed when one or the other of the above conditions [1] and [2] is satisfied. Further, for the predetermined values α1 and β1, empirically obtained values may be used, or corrections may be made to such values by the operator.

The determination method based on the change of weight can be used by it self, but it is preferable to use it in combination with a method using other criteria, in particular, the method using the required time earlier described. The reason is that if an error occurs in the determination of the change of weight, the removal completion determination may enter an endless loop, ending up being unable to issue a completion command. Since the determination of the required time is made based on timer counting and is robust against errors, if this method is combined for use, the removal completion command will be issued without fail. The advantage of combining the required time determination also holds true for the case where the following method using other criteria is employed.

<Determination Based On Change of Flow Rate of Removed Powder>

A method will be described below in which the volume of the removed powder, calculated based on the measurements taken by the flow rate sensor 78, is compared with a predetermined threshold value to determine whether the removal of the unbonded powder remaining on the three dimensional model 91 has been completed in the powder removing apparatus 70.

In this determination method, first the expected volume Ve of the removed powder is calculated in the control unit 10 in order to determine the above threshold value.

The expected volume Ve of the removed powder is calculated by the following equation (3).

Ve=Sa×n×t−Va (3)

where Va is the volume of the three dimensional model derived from the three dimensional data, Sa is the cross sectional area of the recessed portion of the model forming bath 61 taken along the XY plane, n is the number of stacked powder layers, t is the thickness of each powder layer.

When the integrated value (cumulative value) of the measurements taken by the flow rate sensor 78 satisfies the following two conditions relative to the threshold value determined based on the volume of the removed powder calculated by the above equation, the control unit 10 issues a command to stop the powder removing operation.

[3] (Volume of removed powder obtained from flow rate sensor)>(Removed powder volume Ve)−(1−α2)

Here, α2 is subtracted considering measurement errors of the flow rate sensor 78, etc.

[4] (Value measured by flow rate sensor) <β2

The value measured by the flow rate sensor 78 represents the amount of change per unit time of the volume of the removed powder.

Here, the powder removing operation may be completed when one or the other of the above conditions [3] and [4] is satisfied. Further, for the predetermined values α2 and β2, empirically obtained values may be used, or corrections may be made to such values by the operator.

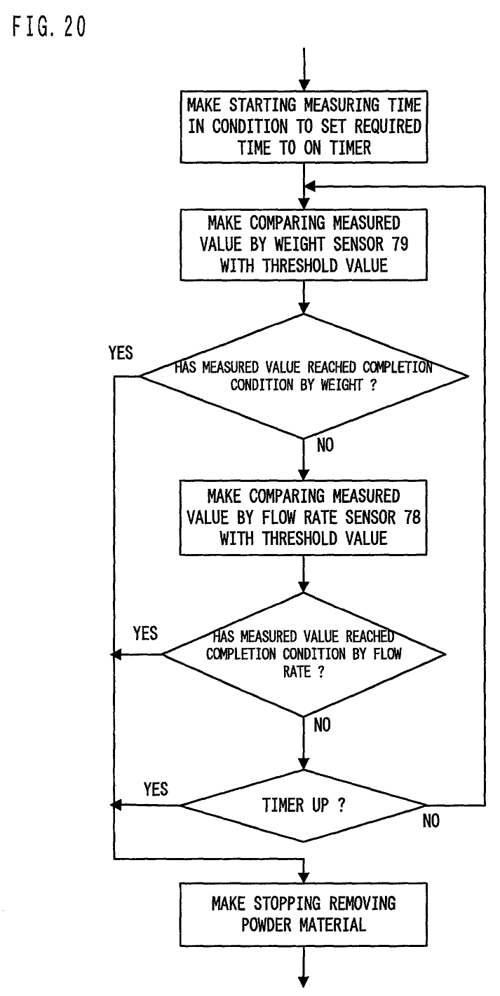

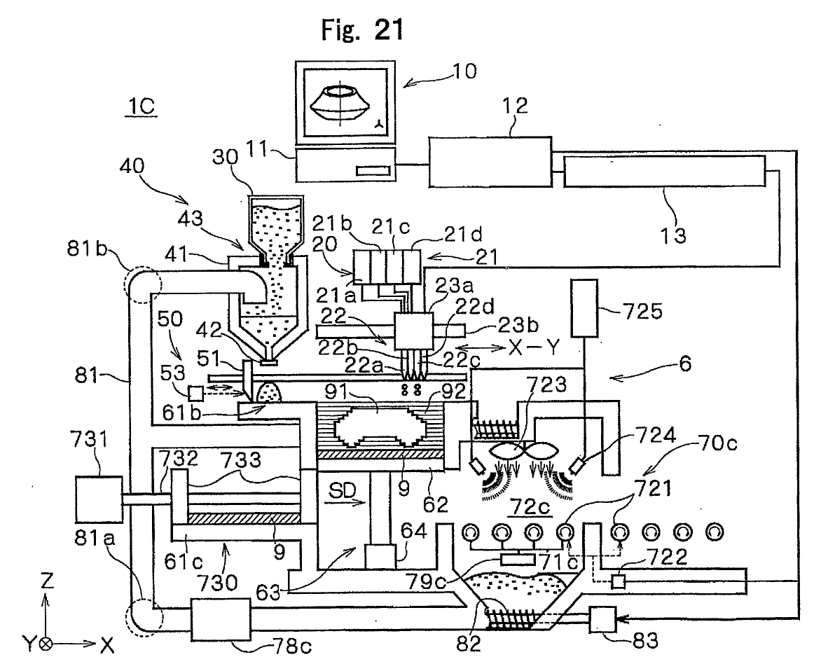

The flow chart of the determination process described above (detailing the process in step S16) is shown in FIG. 20.

<Embodiment 2>

<Construction of Essential Parts of Three Dimensional Modeling System>

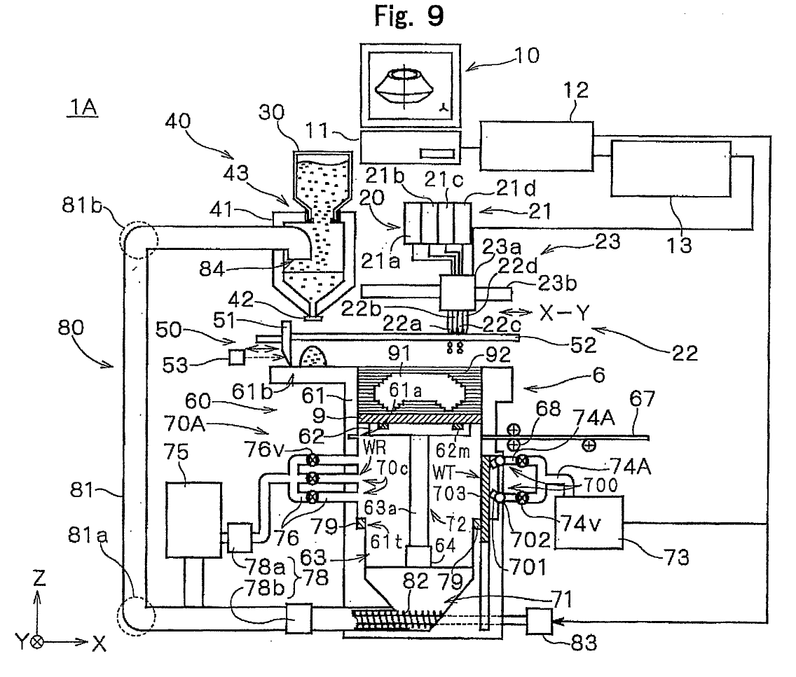

FIG. 9 is a diagram showing the construction of essential parts in a three dimensional modeling system 1A which incorporates a powder removing apparatus 70A according to a second embodiment of the present invention.

The three dimensional modeling system 1A is similar in construction to the three dimensional modeling system 1 of the first embodiment, but differs in the construction of the blower unit WT in the powder removing apparatus 70A.

The blower unit WT comprises a blower driving unit 73 similar to the one shown in the first embodiment, a pipe 74A extending from the air outlet of the blower driving unit 73 and branching into two pipes which terminate at the vertical inner wall 61a, and two blower valves 74v inserted in the respective pipes 74A.

The blower unit WT further includes a nozzle unit 700 connected to the end of each pipe 74A, and a shutter 703.

The nozzle unit 700 comprises an angularly movable blower nozzle 701 and a nozzle driver 702, and is activated by responding to a command signal from the control unit 10. The air blow direction of the blower nozzle 701 can be varied within the XZ plane by means of a motor or the like incorporated in the nozzle driver 702.

The shutter 703 is mounted movably in the Z direction.

<Operation of the Three Dimensional Modeling System 1A>

The three dimensional modeling system 1A is similar in operation to the three dimensional modeling system 1 of the first embodiment, but differs in the powder removing operation (step S9 in FIG. 3) performed in the powder removing apparatus 70A.

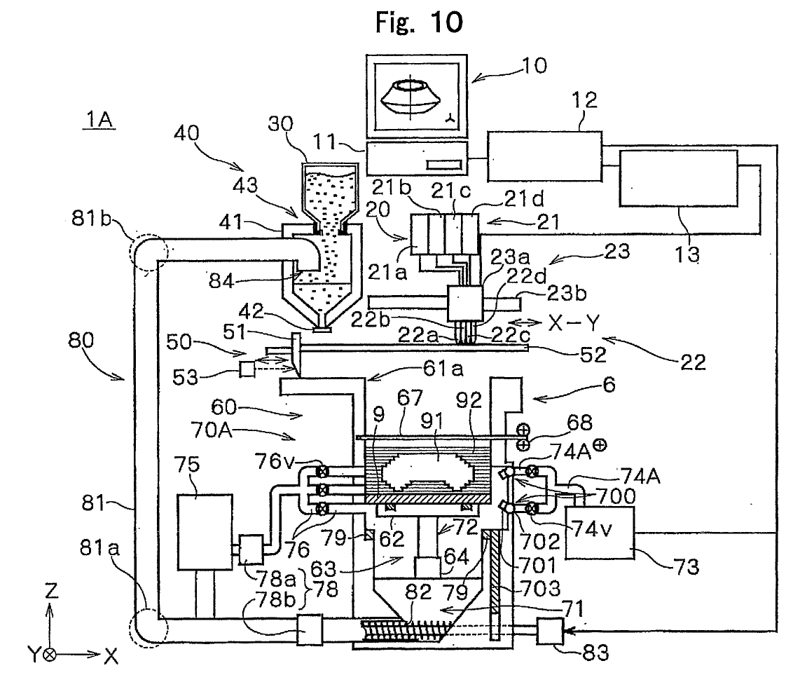

In the powder removing operation, after forming the three dimensional model 91 (FIG. 9), the model forming stage 62 is lowered and the shutter 67 is closed, while at the same time, the shutter 703 on the blower unit WT is opened, as shown in FIG. 10.

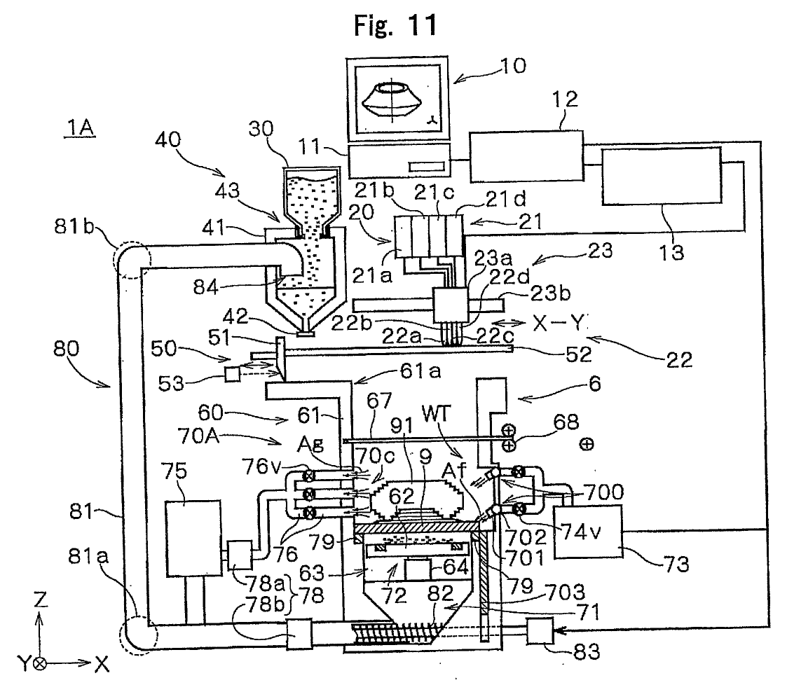

Then, when the meshed tray 9 is separated from the model forming stage 62, as shown in FIG. 11, air is blown from the blower nozzles 701, generating air streams Af, and powder is drawn into the suction apertures 70c with air streams Ag. In this air blow operation, each nozzle driver 702 is driven to control the direction of the air stream Af in such a manner as to track the position of the three dimensional model 91.

Since the direction of the air stream Af from each blower nozzle 701 is variable as just described, powder removal can be performed efficiently by controlling the air blow operation based on the shape of the three dimensional model 91 and on the position of the model forming stage 62 relative to the blower nozzle 701.

With the above operation of the powder removing apparatus 70A, since air can be blown effectively to the three dimensional model 91 through the plurality of apertures for removal of the powder, the unwanted powder material can be efficiently removed.

The blowing direction of each blower nozzle 701 need not necessarily be made variable in the XZ plane, but may instead be made variable in the XY direction. Further, the blowing direction of each blower nozzle 701 need not necessarily be moved in such a manner as to follow the movement of the three dimensional model 91, but the direction may be changed in a random manner. It will also be appreciated that a similar effect to that achieved in this embodiment can be obtained if at least one of the plurality of blower nozzles 701 is made variable in direction.

<Embodiment 3>

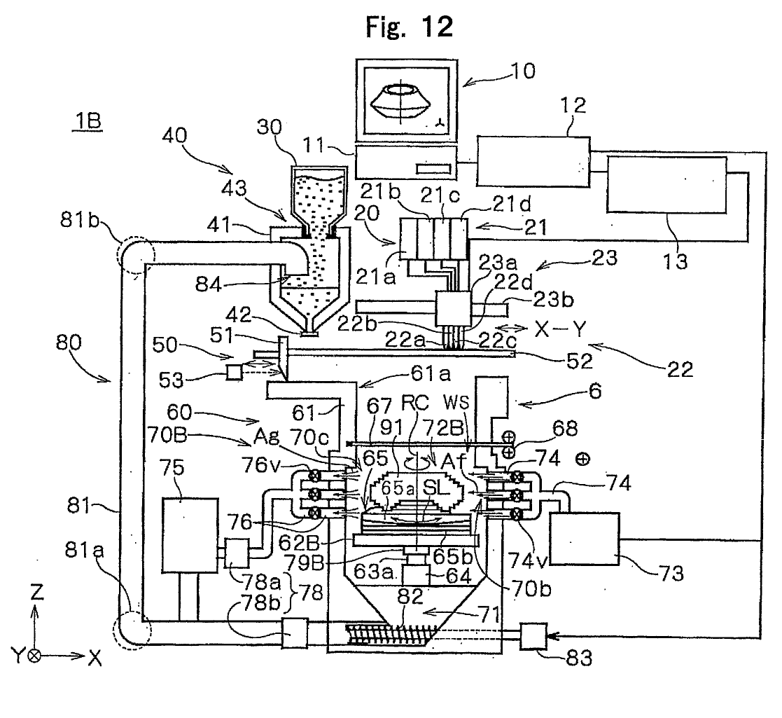

FIG. 12 is a diagram showing the construction of essential parts in a three dimensional modeling system 1B which incorporates a powder removing apparatus 70B according to a third embodiment of the present invention.

The three dimensional modeling system 1B is similar in construction to the three dimensional modeling system 1 of the first embodiment, but differs in the construction of the powder removing apparatus 70B. The following description is given focusing on parts that are different from those in the powder removing apparatus 70 of the first embodiment.

The powder removing apparatus 70B includes a processing chamber 72B having a greater width than the vertical inner wall 61a in the upper part of the model forming bath 61, an orientation changing unit 65 capable of changing the orientation of the three dimensional model 91 on the model forming stage 62B, and a weight sensor 79B mounted between the supporting rod 63a and the model forming stage 62. Here, since the meshed tray 9 is not mounted, the model forming stage 62B is constructed as a flat plate with no holes H2 (FIG. 2(b)) opened therein and the electromagnets 62m provided on the model forming stage 62 of the first embodiment are omitted.

The orientation changing unit 65 comprises a tilting table 65a and a rotating table 65b.

The tilting table 65a has a moving part and a base contacting the moving part on a curved surface, the moving part being slidable in direction SL along the curved surface. With this construction, the three dimensional model 91 placed on the orientation changing unit 65 can be tilted.

The rotating table 65b is disc shaped, and its upper part is rotatable about axis Rc. With this construction, the three dimensional model 91 placed on the orientation changing unit 65 can be rotated (swivelled) in a plane parallel to its bottom surface.

The weight sensor 79B replaces the weight sensor 79 provided in the first embodiment, and measures the weight of the load, including the three dimensional model 91, carried on the model forming stage 62.

<Operation of the Three Dimensional Modeling System 1B>

The three dimensional modeling system 1B is similar in operation to the three dimensional modeling system 1 of the first embodiment, but differs in the powder removing operation (step S9 in FIG. 3) performed in the powder removing apparatus 70B.

In the powder removing operation, after forming the three dimensional model 91 without using the meshed tray 9 of the first embodiment, the model forming stage 62B is lowered and the shutter 67 is closed, as shown in FIG. 12.

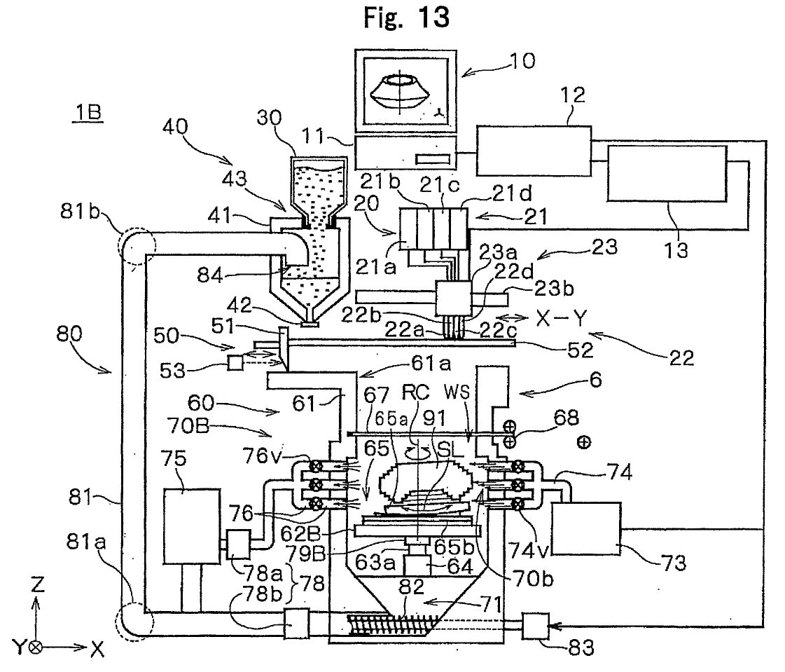

Then, air is blown to the three dimensional model 91 from the blower apertures 70b of the blower unit WS, generating air streams Af, and powder is drawn into the suction apertures 70c with air streams Ag. Here, since the three dimensional model 91 is tilted and rotated about the axis Rc, as shown in FIG. 13, efficient powder removal can be achieved.

When using the value measured by the weight sensor 79B to determine whether the powder removal has been completed or not, the determination is made based on the following relation.

(Value measured by weight sensor−Weight of model forming stage and orientation changing unit)<(Weight of three dimensional model)×(1+α1) (4)

Since, in addition to changing the orientation of the three dimensional model 91 by the orientation changing unit 65, the position of the three dimensional model 91 relative to the direction of air streams from the blower apertures 70b can be changed by moving up and down the model forming stage 62 with the three dimensional model 91 placed thereon, further effective powder removal can be achieved.

If the nozzle unit 700 of the second embodiment is incorporated in the powder removing apparatus 70B, the efficiency of powder removal can be further enhanced.

In order to facilitate the powder removal, it is preferable to form the three dimensional model 91 with its recessed portion facing straight down, as earlier described; however, in the powder layer laminating modeling method, the upper surface tends to be finished with better smoothness and better precision than the surface on the downstream side, and there may be cases in which it is desirable to form the three dimensional model 91 with the surface desired to be finished with good precision facing straight upward. In such cases, after forming the three dimensional model 91 with the opening of its recessed portion facing up, the orientation changing unit 65 is driven to change the position of the three dimensional model 91 relative to the blower apertures 70b so that the unbonded powder can be removed efficiently.

With the above operation of the powder removing apparatus 70B, since the orientation of the three dimensional model can be changed during the powder removing operation, the unwanted powder material can be removed efficiently.

<Modified examples>

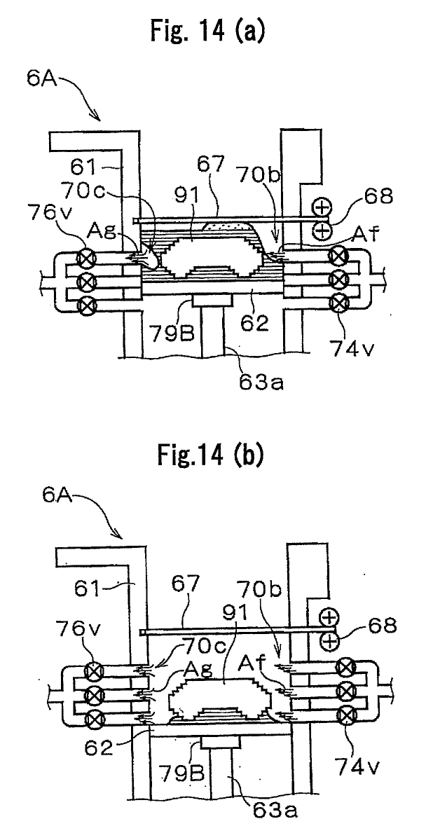

In the three dimensional modeling system of the third embodiment, the orientation changing unit 65 mounted on the model forming stage 62B may be omitted as illustrated in the construction of the model forming unit 6A shown in FIG. 14.

According to the powder removing operation in the model forming unit 6A, while the model forming stage 62 is being lowered, air is first blown from the upper blower aperture 70b, generating an air stream Af, and powder is drawn into the upper suction aperture 70c with an air stream Ag (FIG. 14(a)). As the model forming stage 62 is further lowered, air streams Af flowing out of the middle and lower blower apertures 70b and air streams Ag flowing into the middle and lower suction apertures 70c are sequentially added (FIG. 14(b)).

By selectively generating the air streams Af and Ag as described, the unbonded powder can be removed efficiently though the efficiency drops somewhat compared with the efficiency achieved when the orientation of the three dimensional model 91 is changed.

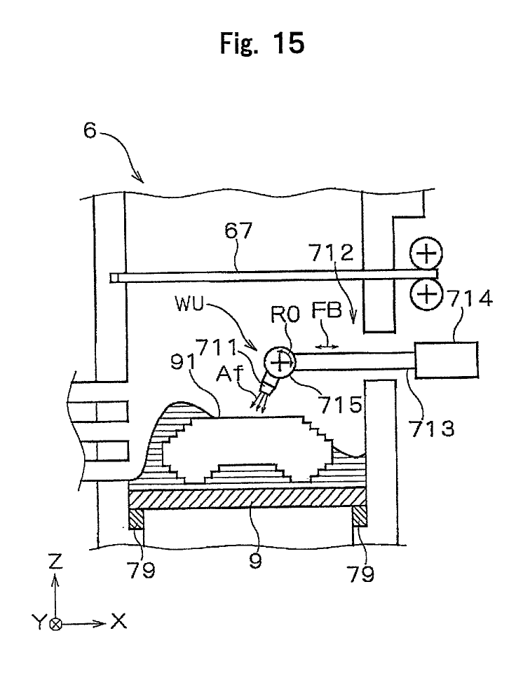

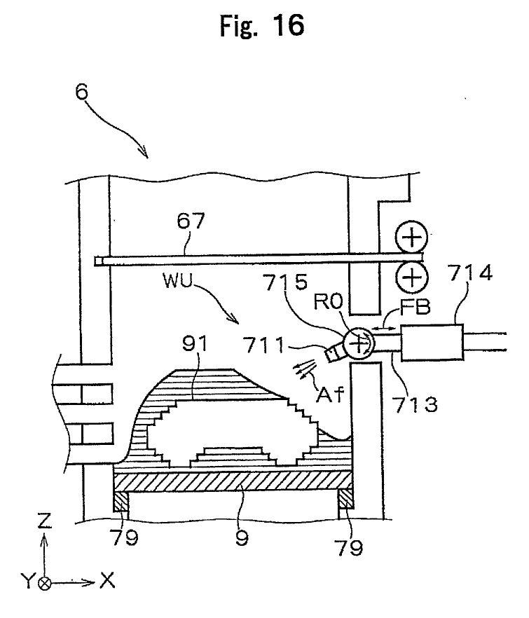

The blower unit in each of the above embodiments may be replaced by a blower unit WU having the configuration shown in FIG. 15.

The blower unit WU comprises a blower nozzle 711 and a robot arm 712.

The robot arm 712 comprises an arm 713, a horizontal driving unit 714 for moving the arm 713, and a rotary driving unit 715 for changing the orientation of the blower nozzle 711.

Driven by the horizontal driving unit 714 and the rotary driving unit 715, the blower nozzle 711 not only can be moved horizontally in sliding fashion along direction FB but also can be rotated in direction RO.

Using the robot arm 712, air can be blown to the three dimensional model 91 from various directions by changing the direction of the air stream Af, one example being shown in FIG. 15.

With the blower unit WU having the above configuration, the efficiency of unbonded powder removal operation can be further enhanced.

The robot arm may be configured so that it can be used for sucking unbonded powder material. In that case, air blowing is not always necessary.

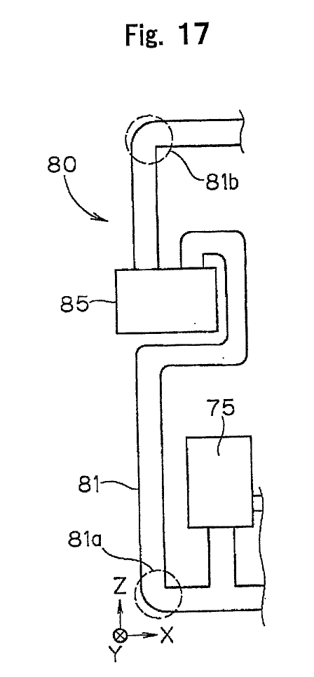

A refresh unit 85 for refreshing unbonded powder material may be incorporated in the powder recovering unit 80 in each of the above embodiments (see FIG. 17).

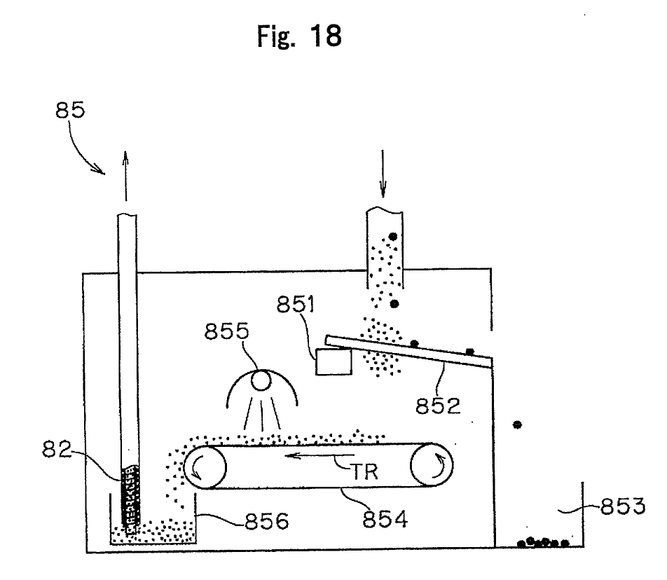

FIG. 18 shows the construction of an essential portion of the refresh unit 85.

The refresh unit 85 comprises a vibrator 851, a sieve 852 which is vibrated by the vibrator 851, a foreign particle collection container 853, a conveyor belt 854, a heat source 855, and a conveyor container 856.

In the refresh unit 85, first the powder particles falling on the sieve 852 are separated by the sieve 852, which is being vibrated by the vibrator 851, into reusable fine powder particles, which are allowed to fall on the conveyor belt 854, and larger powder particles, which are collected as foreign particles in the foreign particle collection container 853.

Next, with the driving of the conveyor belt 854, the powder is conveyed in direction TR, dried by the light source 855, and collected in the conveyor container 856. The powder collected in the conveyor container 856 is conveyed to the powder dispensing unit 40 by means of the powder conveying screw 82.

The powder recycled to the tank 41 in the powder dispensing unit 40 is mixed with the virgin powder contained in the powder material container 30, and used for forming the model. Here, the recovered powder may be used in preference to virgin powder by making provisions, for example, to supply the recovered powder in the tank 41 to the model forming unit 6 until it is nearly depleted and to replenish virgin powder from the powder material container 30 as it is depleted.

With the above operation of the refresh unit 85, reusable powder can be recycled to the powder dispensing unit 40, and the three dimensional model 91 of good quality can be formed economically.

Alternatively, the refresh unit 86 described hereinafter may be incorporated in the powder recovering unit 80.

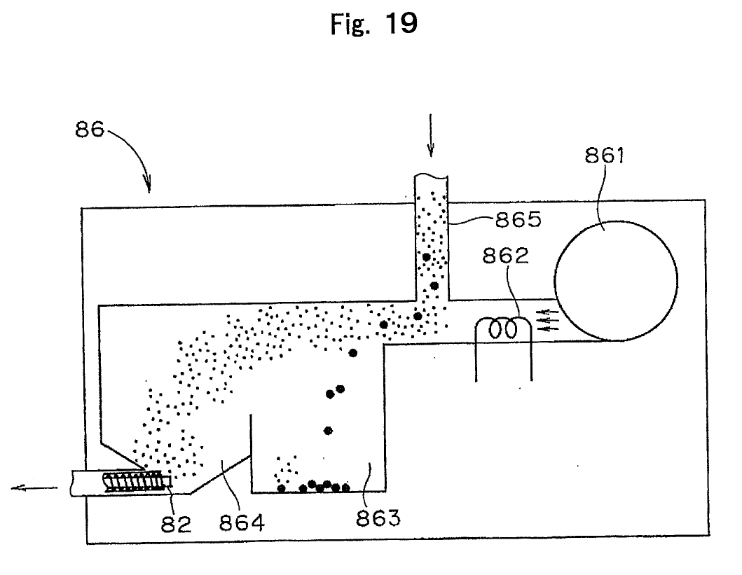

FIG. 19 is a diagram showing the construction of an essential portion of the refresh unit 86.

The refresh unit 86 comprises an air blower 861, a heater 862, a foreign particle collection container 863, and a conveyor container 864.

In the refresh unit 86, powder particles that fell through an inlet 865 are dried by air generated by the air blower 861 and heated by the heater 862, and relatively heavy, foreign particles are allowed to fall into the foreign particle collection container 863. On the other hand, relatively light, reusable powder particles are blown off by the heated air and fall into the conveyor container 654. The powder collected in the conveyor container 654 is conveyed to the powder dispensing unit 40 by means of the powder conveying screw 82.

With the above operation of the refresh unit 86, as with the refresh unit 85, reusable powder can be recycled to the powder dispensing unit 40, and economical fabrication of the three dimensional model 91 of good quality can be realized.

In each of the above embodiments, the blower apertures are formed in one side of the inner wall of the model forming bath, and the suction apertures in the opposite side of the inner wall section, but the arrangement is not limited to the illustrated one; for example, the suction aperture array may be arranged directly below the blower aperture array, or the suction apertures may be arranged in such a manner as to alternate with the blower apertures in a vertical direction.

Alternatively, the blower apertures may be arranged around the circumference of the model forming bath so that air can be blown to the entire circumference of the model by sequentially operating such apertures.

In the powder removing apparatuses of the first and second embodiments, a vibrator for generating fine vibrations maybe connected to the meshed tray to increase powder flowability and thereby make unbonded powder to fall therethrough efficiently. For the vibrator, a pager motor with a weight attached off center to the motor's rotation axis, a piezoelectric ceramic, or the like can be applied. In this case, it is desirable that the frequency of vibrations applied to the meshed tray be made variable according to the particle size, mass, etc. of the powder material so that optimum vibrations can be applied to increase the flowability of powder particles.

In each of the above embodiments, blowing air into the processing chamber through blower apertures is not an essential requirement; for example, a plurality of fans may be arranged inside the processing chamber to generate a plurality of air streams and apply them to the three dimensional model.

In the process of determining the completion of powder removal in each of the above embodiments, if the process is forcefully terminated because the preset time period has expired, it is preferable to display an alarm indication on the monitor of the control unit or on the surface of the model forming unit to indicate that the powder removal is forcefully terminated and to prompt the operator to remove powder by hand.

In each of the above embodiments, if the rate of change of the flow rate of the removed powder or the rate of change of weight relating to the three dimensional model is lower than the expected value, and it is determined that the efficiency of powder removal has dropped, control may be performed, for example, by increasing the air flow speed or pressure in order to increase the efficiency of powder removal.

In each of the above embodiments, the amount of removed powder need not necessarily be measured using the flow rate sensor 78, but it may be measured using the weight sensor.

Further, in the embodiments having more than one suction aperture 70c, the flow rate sensor may be provided in the pipe connecting to each suction aperture 70c.

In the first and third embodiments, the blower apertures may each be formed in the shape of a slit extending parallel to the model forming stage. The blower apertures of such shape are effective in removing unbonded powder because air can be blown uniformly to the circumference of the three dimensional model by ejecting air through the blower apertures while moving the model forming stage up and down.

In the first and second embodiments, using electromagnets to fix the meshed tray to the model forming stage is not an essential requirement, but instead, a mechanical locking/unlocking means may be used.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being included therein.

What is claimed is:

1. A removing apparatus for removing unbonded powder material remaining around a three dimensional model which is a bonded structure of the powder material, comprising:
a processing chamber in which processing is performed to remove the unbonded powder material from the three dimensional model; and
an air blower for generating within the processing chamber a plurality of air streams directed to the three dimensional model.

2. The removing apparatus of claim 1, wherein the processing chamber has a plurality of openings for conducting the plurality of air streams from the outside of the processing chamber.

3. The removing apparatus of claim 1, wherein the three dimensional model is formed by repeating the step of selectively depositing a binder material to a layer of the powder material to form the bonded structure of the powder material.

4. A removing apparatus for removing unbonded powder material remaining around a three dimensional model which is a bonded structure of the powder material, comprising:
a processing chamber in which processing is performed to remove the unbonded powder material from the three dimensional model;
an air blower for generating within the processing chamber an air stream directed to the three dimensional model; and
a changer for changing the direction of the air stream.

5. A removing apparatus for removing unbonded powder material remaining around a three dimensional model which is a bonded structure of the powder material, comprising:
a processing chamber in which processing is performed to remove the unbonded powder material from the three dimensional model; and
a sucking device for,generating within the processing chamber a plurality of air streams for sucking the unbonded powder material.

6. The removing apparatus of claim 5, wherein the processing chamber has a plurality of sucking openings for exhausting the plurality of air streams to the outside of the processing chamber.

7. A removing apparatus for removing unbonded powder material remaining around a three dimensional model which is a bonded structure of the powder material, comprising:
a remover for removing the unbonded powder material from the three dimensional model; and
a changing device for changing the orientation of the three dimensional model during the removal of the unbonded powder material by the remover.

8 A three dimensional modeling system having the removing apparatus of claim 1, comprising:
a supplying device for supplying powder material to form a three dimensional model which is a bonded structure of the powder material;
a collecting device for collecting the unbonded powder material which is removed from the three dimensional model by the removing apparatus; and
a conveying device for conveying the unbonded powder material from the collecting device to the supplying device.

9 A three dimensional modeling system having the removing apparatus of claim 4, comprising:
a supplying device for supplying powder material to form a three dimensional model which is a bonded structure of the powder material;
a collecting device for collecting the unbonded powder material which is removed from the three dimensional model by the removing apparatus; and
a conveying device for conveying the unbonded powder material from the collecting device to the supplying device.

10 A three dimensional modeling system having the removing apparatus of claim 5, comprising:
a supplying device for supplying powder material to form a three dimensional model which is a bonded structure of the powder material;
a collecting device for collecting the unbonded powder material which is removed from the three dimensional model by the removing apparatus; and
a conveying device for conveying the unbonded powder material from the collecting device to the supplying device.

11 A three dimensional modeling system having the removing apparatus of claim 7, comprising:
a supplying device for supplying powder material to form a three dimensional model which is a bonded structure of the powder material;
a collecting device for collecting the unbonded powder material which is removed from the three dimensional model by the removing apparatus; and
a conveying device for conveying the unbonded powder material from the collecting device to the supplying device.

12. A removing apparatus for removing unbonded powder material remaining around a three dimensional model which is a bonded structure of the powder material, comprising:
a remover for removing the unbonded powder material from the three dimensional model;
a measuring device for measuring a prescribed value indicative of how far the removal of the unbonded powder material has progressed; and
a controller for deactivating the remover when the measured value reaches a prescribed completion condition after the remover has been activated.

13. The removing apparatus of claim 12, the measuring device measures a total weight of the three dimensional model and the unbonded powder material as the prescribed value.

14. The removing apparatus of claim 12, the measuring device measures an amount of change per unit time of a total weight of the three dimensional model and the unbonded powder material as the prescribed value.

15. The removing apparatus of claim 12, the measuring device measures a volume of the removed unbonded powder material as the prescribed value.

16. The removing apparatus of claim 12, the measuring device measures an amount of change per unit time of a volume of the removed unbonded powder material as the prescribed value.

17. The removing apparatus of claim 12, the measuring device measures a time passed from activating the remover as the prescribed value.

18. The removing apparatus of claim 12, the three dimensional model is formed on the basis of a three dimensional data, the prescribed completion condition being determined on the basis of the three dimensional data.

19. The removing apparatus of claim 18, the prescribed completion condition is determined on the basis of a weight of the three dimensional model, the weight calculated on the basis of the three dimensional data.

20. The removing apparatus of claim 18, the prescribed completion condition is determined on the basis of a time for removing the unbonded powder material, the time calculated on the basis of the three dimensional data.

21. The removing apparatus of claim 12, comprising a changing device for changing the orientation of the three dimensional model according to the measured value.

22. The removing apparatus of claim 21, wherein the remover comprises an air blower for generating an air stream directed to the three dimensional model, and the changing device comprises an orientation controller for controlling the orientation of the three dimensional model according to relative positions of the three dimensional model and the air stream.
